(19) United States
(12) Patent Application Publication
(10) Pub. No.: US 2005/0198137 A1
(43) Pub. Date: Sep. 8, 2005

(54) Web server comprising integrated automation functionality

(76) Inventors: Rolf-Dieter Pavlik, Erlangen (DE); Gernot Rossi, Simmelsdorf (DE); Frank Volkmann, Nurnberg (DE)

Correspondence Address: Siemens Corporation;Intellectual Property Department, 170 Wood Avenue South, Iselin, NJ, 08830, US

(21) Appl. No.: 10/510,225

(22) PCT Filed: Mar. 24, 2003
(86) PCT No.: PCT/DE03/00966

§ 371 Date: Oct. 1, 2004

(30) Foreign Application Priority Data
Apr. 2, 2002 (DE) 102 14 541.5

(51) Int. Cl. G06F 15/16

(52) U.S. Cl. 709/205; 709/203

(57) ABSTRACT

The invention relates to a web server comprising software modules that are integrated in said server. At least one first software module of the web server has first means for a non-proprietary implementation of automation functionality.

### CROSS REFERENCE TO RELATED APPLICATIONS

This application is the US National Stage of International Application No. PCT/DE03/00966, filed Mar. 24, 2003 and claims the benefit thereof. The International Application claims the benefits of German application No. 10214541.5 filed Apr. 2, 2002, both of the applications are incorporated by reference herein in their entirety.

### FIELD OF INVENTION

The invention relates to a web server comprising software modules which are integrated into the web server and an automation system or, as the case may be, a computer program product comprising a web server of said type.

### BACKGROUND OF INVENTION

Servers that are linked via the internet to clients and make information, typically internet pages, available to these clients are called web servers. A web server of said kind is an application which runs on a single computer or in a distributed manner on a plurality of computers. The web server provides centralized storage for data which can be used by many different clients, regardless of the particular location of a client. The term “web server” is used to describe both the software application executing on a computer and also the computer itself. Web servers are nowadays used as a general-purpose means of delivering information in the internet, but also in local area networks which are based on internet technologies. In this arrangement use is often made of the possibility of extending the web servers with expansion modules, for example in order to enable access to databases, forms, etc. The communication between client and web server usually takes place in accordance with the HTTP protocol (HTTP=Hyper Text Transfer Protocol).

U.S. Pat. No. 6,061,603 A describes a control system which allows a user to access a programmable logic controller over a communication network such as, for example, the Internet using a web browser. The system includes an interface between the network and the programmable logic controller. This web interface, as it is called, provides internet pages from an Ethernet interface of the programmable logic controller and includes an HTTP protocol interpreter and a TCP/IP stack (TCP/IP=Transmission Control Protocol/Internet Protocol). The web interface thus offers a remote user access to the programmable logic controller via the internet.

### SUMMARY OF INVENTION

The object of the invention is to disclose a possible non-proprietary solution for implementing an automation functionality.

This object is achieved by means of a web server comprising software modules in which at least a first software module has first means for implementing an automation functionality.

The invention is based on the knowledge that at the present time the conventional automation world has few points of contact with the internet due to the fact that in automation technology use is made predominantly of proprietary protocols. This notwithstanding, the development of web technology is advancing apace without issues relating to automation technology being taken into account. Previous approaches to integrating dedicated web server functionality into the automation components are in turn based on proprietary solutions for the individual components. Moreover, the performance of solutions of said kind revealed itself to be very limited. The web server according to the invention combines web technology with automation technology in an unexpected manner, in that an expansion module, typically a software module, which is integrated directly in the web server provides the required automation functionality. A web server whose functionality is extended in such a way is capable of processing not only complex tasks of conventional automation technology but also applications on a smaller scale, for example in the consumer domain. The direct integration of the automation functionality into the web server means that existing web implementations can also be used in the processing of the automation function.

As a result of the connection of the web server according to the invention to a communication network, in particular the internet, on the one hand internet technologies are made accessible to automation technology and on the other hand an end-to-end connection of the automation components to the communication network or, as the case may be, the internet is achieved.

The use of internet protocols for communication between the software modules themselves and for communication between the software modules and components located outside of the web server enables the standardization of the components of the web server with regard to their communication interfaces. Expansion of the web server with further modules is facilitated, since said modules can be used without complex and time-intensive adaptation to proprietary protocols. Example of typical internet protocols are HTTP and FTP (File Transfer Protocol).

In an advantageous embodiment of the invention the web server is provided for the configuration and administration of the software modules.

The web server according to the invention is easily scalable and so can be used, according to a further advantageous embodiment, for controlling the components of an industrial automation system if the first software module has a connection to the industrial automation system.

In order to use available internet security mechanisms it is proposed that the web server has a connection to the internet via a firewall. In the case of the already typical web server expansions integrated into an automation component, the security mechanisms required in the internet usually cannot be implemented because of the limited scope for modification.

The connection of the web server to a communication network, in particular the internet, can be advantageously used to support the automation functionality if the web server is linked via a communication network to a web browser as the control and monitoring system for the automation system controlled by the first software module. This control and monitoring system can also be used for project planning, for configuration, for programming, and for rolling out software updates, in other words generally for data communication and data representation.

In order to enable web technologies to be used also for real-time applications it is proposed that the web server has a real-time operating system. In particular when deployed in process automation, the automation components used must have real-time capability. This requirement can be met by coupling of the first software module to the real-time operating system. The real-time operating system can be used in addition to a non-real-time-capable operating system (part) or as a standalone operating system.

The invention will be described and explained in more detail below with reference to the exemplary embodiments represented in the figures, in which:

### BRIEF DESCRIPTION OF THE DRAWINGS

FIG. 1 shows a system comprising web servers which are interconnected via the internet and fulfill different tasks,

FIG. 2 shows a web server comprising automation functionality, and

FIG. 3 shows a schematic view of the structure of a web server comprising automation functionality.

### DETAILED DESCRIPTION OF INVENTION

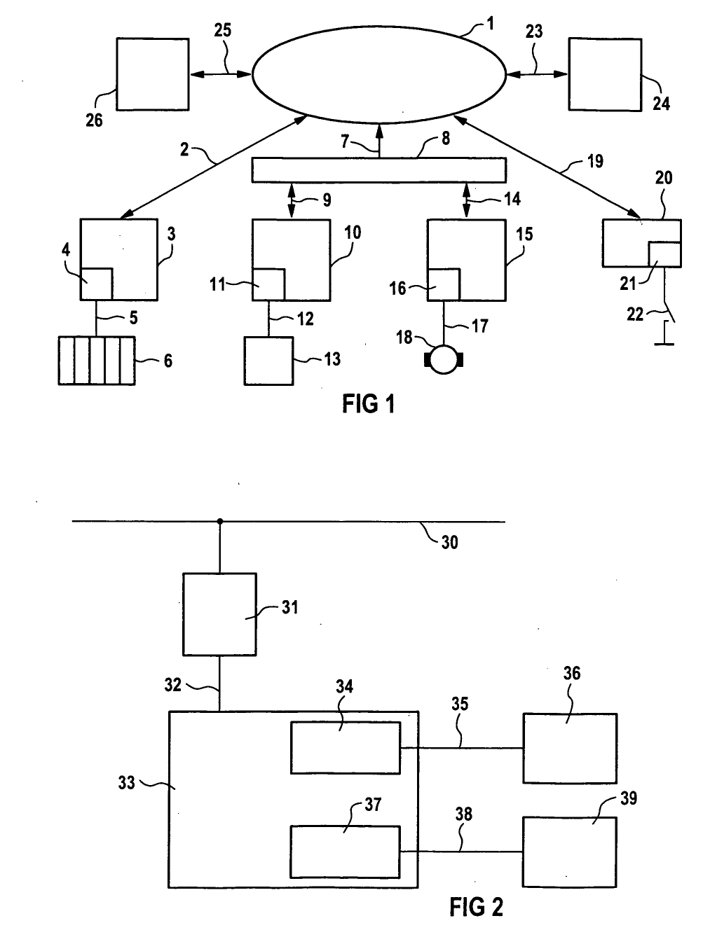

FIG 1 shows different web servers 3, 10, 15, 20, 24 which are connected to one another directly or indirectly via the internet 1. A first web server 3 communicates directly with the internet 1 via a connection 2. The first web server 3 includes an expansion module 4 which is connected via a connection 5 to an input/output module 6 of an automation system. A second and a third web server 10, 15 are connected to the internet 1 via connections 9, 14, a firewall 8 and a connection 7. The second web server 10 has an expansion module 11 which has a connection 12 to a converter 13. The third web server 15 includes an expansion module 16 which controls a drive 18 via a connection 17. The reference numeral 20 identifies a fourth web server, referred to as an embedded web server, which is connected directly to the internet 1 via a connection 19 and has an expansion module 21 which controls a valve 22. The fifth web server 24 shown in FIG. 1 possesses no automation functionality whatsoever and communicates with the internet via a connection 23. A web browser 26 is connected to the internet 1 via a connection 25.

The idea on which the invention is based will be explained below with reference to FIG. 1. A web server is a process running on a computer—or also distributed over a plurality of computers—and typically supplies very many clients (web browsers on different devices) with information. This information can either reside statically on the web server or else be generated dynamically by further utility routines. Typical communication partners connected via the internet 1 are therefore web servers in the embodiment of the fifth web server 24 and web browser 26. The fifth web server 24 provides information, generally internet pages, via the internet 1 in response to a request from a web browser 26. The idea of the invention is thus to configure a standard web server of this type through expansion by means of software modules in such a way that it can also solve automation tasks. The first web server 3 includes an expansion module 4 which takes on the functions of a programmable logic controller (PLC). Toward that end, the expansion module 4 as part of the web server 3 is additionally connected to an input/output module of an automation system by means of a connection 5. The first web server 3 therefore serves not only to deliver information into the internet 1 via the connection 2, but can also, thanks to the integration of the expansion module 4, execute complex control tasks which in the prior art were previously only executable by means of independent programmable logic controllers. A further exemplary embodiment of the web server according to the invention is shown in FIG. 1 in the second web server 10 which has an expansion module 11 comprising CNC (CNC=Computer Numerical Control) functionality. Via the expansion module 11, the second web server 10 controls a computer-controlled machine tool 13 (CNC machine tool) which is used for fast and precise production of complex turned and milled parts. Complex controls of said kind are usually executed by computers specified explicitly for that purpose. The control of a drive 18 which is handled by the third web server 15 in the exemplary embodiment reveals itself as a similarly complex control task. For this purpose the third web server 15 includes an expansion module 16 which assumes the demanding tasks of controlling and/or regulating the drive 18. In order not to pay for the advantages of using web technologies by the second and the third web server 10, 15 at the expense of the disadvantage of absence of security, the web servers 10, 15 are linked to the internet 1 via a firewall 8. The firewall 8 effectively prevents illegal accesses via a communication connection 7 to one of the web servers and therefore to the drive 18 or the machine tool 13. In a further exemplary embodiment of the invention shown in FIG. 1, the web server comprising automation functionality is what is known as an embedded web server 20 which includes, in the form of expansion module 21, a temperature controller for controlling a valve 22. This embedded web server 20 is implemented for example as a single-chip solution within a personal computer (PC). In addition to the automation functionality of the expansion modules, each of the described web servers 3, 10, 15 and 20 also provides all the functionalities and therefore all the advantages of a standard web server 24. Thus, the web browser 26 connected via the internet 1 can also make use of web technologies to access the web servers 3, 10, 15 and 20 that have been extended with automation functionality and so be used, for example, as a control and monitoring system. The exemplary embodiments illustrated in FIG. 1 clearly show the better scalability of the solution proposed here in contradistinction to traditional approaches. The web server can be embodied as a single-chip web server with hardware add-on (e.g. in the consumer domain) right through to a high-performance web server featuring SoftPLC and Office software.

FIG 2 shows an exemplary embodiment of a web server comprising automation functionality in a schematic view. A web server 33 is connected via a connection 32 and a TCP/IP stack 31 to a TCP/IP connection 30. The web server 33 includes a first expansion module 34 which is embodied as a database module and has access by means of a connection 35 to a SQL7 server 36 (SQL=Structured Query Language). A second expansion module 37 possesses automation functionality and communicates via a connection 38 with an industrial process 39. The expansion module 37, a software module, is coupled via an interface (not shown in the figure) to the connection 38 and therefore to the hardware components of the automation system for controlling the industrial process 39. As front-end software, the TCP/IP stack controls the accesses to a network card (not shown in the figure) which has access to the TCP/IP connection 30 and makes the TCP/IP protocol available to the accessing processes.

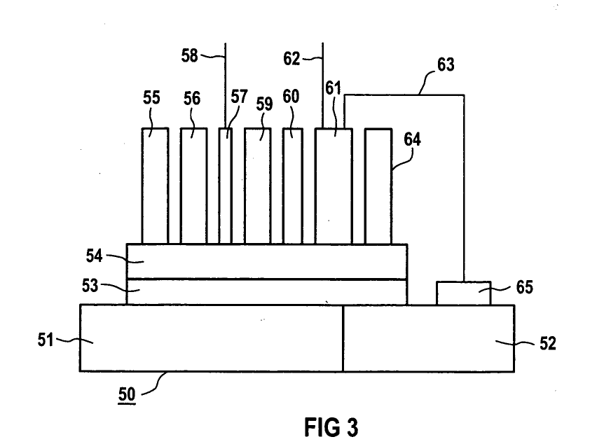

FIG 3 shows the schematic view of the structure of a further exemplary embodiment of a web server comprising automation functionality. Software components of the web server are depicted. An operating system 50 of the computer on which the web server runs includes a standard operating system 51 as well as a real-time operating system 52. A web server kernel 54 is superimposed on top of the underlying operating system 50 using the intermediary of a porting 53. The web server kernel 54 provides standardized interfaces for coupling the software components and forms the basis for various software expansion modules. A first expansion module 55 serves to provide web pages, while a second expansion module 56 serves as an XML parser. A Profibus access 58 is connected by means of a third expansion module 57. A fourth expansion module 59 provides Java functionality, while a fifth expansion module 60 processes signals of a webcam. A sixth expansion module 64 serves for processing XML data. A seventh expansion module 61 comprising automation functionality has a connection 62 to a process and a connection 63 to an interface 65 to the real-time operating system 52. A system is regarded as real-time-capable if it can react to random external events within a specifiable and guaranteeable time. Reaction times in the microsecond range are typical and essential in industrial automation systems. Real-time processes can use all the services which are also available to other processes.

The operating system 50 has direct access to the resources of the computer, such as, for example, memory and computing time. When a command is sent off or a program invoked, the required program code is loaded into a main memory and started as a process. Processes have no access to the resources, but request these from the operating system in each case.

The direct integration of the automation functionality into the web server in the form of the seventh expansion module 61 makes the performance, services (e.g. autotopology, SSDP, SNMP, e-mail etc.) and the openness of the internet accessible to the automation world and enables the additional above-described advantages to be achieved. The seventh expansion module 61 on the one hand implements the automation solution and on the other hand exchanges information via the web server and is configured and administered by said web server. In contrast to this, in the case of a so-called SoftPLC (=software simulation of a programmable logic controller) the automation function is not integrated into the server, but is installed in parallel thereto, possibly connected via a communication interface. Integration in the server means in particular that an expansion module is loaded, configured, started and terminated directly by the web server. An expansion module of this kind is frequently referred to also as an “extension”. The web server kernel 54 of the web server according to the invention serves as a common platform for the expansion modules. This facilitates in particular the configuration of the software expansion modules and their reuse in other applications. The expansion modules are not coupled by means of proprietary interfaces or interfaces which have been programmed out, but are connected by means of standardized interfaces, for example API (Application Programming Interface) or CGI (Common Gateway Interface). API is a formally defined interface via which application programs can use system services (network, operating system, etc.) or services of other application programs. CGI describes a standard interface between a web server and programs. As means for implementing an automation functionality, the seventh expansion module 61 has regulation and/or control means for regulating and/or controlling components and processes of an automation system. Said regulation and control means for controlling an automation system are typically embodied as software processes which are executable in the expansion module.

The proposed web server is part of a system of distributed applications that is constructed on the basis of a client-server architecture. In a system of this kind it is the task of a server as the provider of a service to perform calculations or other internal processes in response to requests from a client and to formulate its results as protocol-compliant answers and pass them on to the requesting client. The term “client” in this case refers to a device or a process which makes use of the service of one or more servers. Usually, therefore, the server makes a service available passively and waits for a client to submit a request to it. The client, on the other hand, makes no services available but instead avails itself of services provided by a server. A server as the provider of a service can reside on the same device as the client or on a different device which is accessible via a network (for example the internet). The client-server communication obeys certain rules and formal descriptions, called protocols. It is an essential requirement for successful communication between client and server that both sides use the same protocol. Such a protocol typically specifies the communication channels and the formats used for login, information exchange, request, response and logoff. Not all of these steps have to be specified explicitly in every case if they are not relevant to the purpose of the application. Protocols are specified at the most diverse abstraction levels and normally build one on top of the other. In that case the structure is referred to as a layer model (e.g. the ISO/OSI layer model). Whereas the lowest layers regulate the communication of hardware and devices—electrical signals, cables or radio frequencies and their characteristics are specified—the middle layers are concerned with the building of network topologies (address structures and their resolution, routing, and error correction). In this case the network layer (e.g. IP=Internet Protocol) is often separated from the transport layer (e.g. TCP=Transmission Control Protocol). The topmost layers are referred to as the application layer. At this level it is specified how actual client-server applications communicate with one another. Examples of such application layer protocols are HTTP (Hyper Text Transfer Protocol), FTP (File Transfer Protocol) and SMTP (Simple Mail Transfer Protocol).

In summary, the invention therefore relates to a web server comprising software modules which are integrated into the web server, in which web server at least a first software module 37 has first means for the non-proprietary implementation of an automation functionality.

1-10. (canceled)

11. A web server comprising software modules, wherein a first software module comprises a first mechanism for implementing an automation functionality.

12. The web server according to claim 11, further comprising a connection to a communication network.

13. The web server according to claim 12, wherein the communication network is the Internet.

14. The web server according to claim 11, wherein Internet protocols are provided for communicating between the software modules and for communicating between the software modules and components outside of the web server.

15. The web server according to claim 12, wherein Internet protocols are provided for communicating between the software modules and for communicating between the software modules and components outside of the web server.

16. The web server according to claim 11, wherein the web server is adapted for configuring and administrating the software modules.

17. The web server according to claim 12, wherein the web server is adapted for configuring and administrating the software modules.

18. The web server according to claim 14, wherein the web server is adapted for configuring and administrating the software modules.

19. The web server according to claim 11, wherein the first software module has a connection to an industrial automation system.

20. The web server according to claim 12, wherein the first software module has a connection to an industrial automation system.

21. The web server according to claim 14, wherein the first software module has a connection to an industrial automation system.

22. The web server according to claim 16, wherein the first software module has a connection to an industrial automation system.

23. The web server according to claim 11, wherein the web server comprises a connection to the Internet via a firewall.

24. The web server according to claim 11, wherein the web server is connected via a communication network to a web browser as a control and monitoring system.

25. The web server according to claim 12, wherein the web server is connected via a communication network to a web browser as a control and monitoring system.

26. The web server according to claim 14, wherein the web server is connected via a communication network to a web browser as a control and monitoring system.

27. The web server according to claim 11, wherein the web server has a real-time operating system.

28. An automation system comprising a web server, wherein the web server comprises software modules, wherein a first software module comprises a first mechanism for implementing an automation functionality.

29. A computer program product comprising a web server, wherein the web server comprises software modules, wherein a first software module comprises a first mechanism for implementing an automation functionality.
